(19) United States
(12) Patent Application Publication
(10) Pub. No.: US 2009/0319829 A1
(43) Pub. Date: Dec. 24, 2009

(54) PATTERN EXTRACTION METHOD AND APPARATUS

(75) Inventor: Koichiro Takayama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/402,228

(22) Filed: Mar. 11, 2009

(30) Foreign Application Priority Data
Jun. 23, 2008 (JP) 2008-163075

(51) Int. Cl. G06F 11/263

(52) U.S. Cl. 714/32; 714/E11.177

(57) ABSTRACT

A test pattern extraction method includes obtaining an identifier of a processing executed for a test pattern by a verification target, and storing the identifier of the processing into a test result data storage device in association with the test pattern; calculating a distance between the test patterns whose identifiers of the processing are different each other and which are stored in the test result data storage device, identifying, for each pair of the identifiers of the processing, a pair of the test patterns whose distance satisfies a predetermined condition, and storing data of the identified pair of the test patterns into a pattern data storage device.

### CROSS-REFERENCE TO RELATED APPLICATIONS

This application is based upon and claims the benefit of priority of the prior Japanese Patent Application No. 2008-163075, filed on Jun. 23, 2008, the entire contents of which are incorporated herein by reference.

### FIELD

This technique relates to a technique to effectively carry out design verification of hardware and/or a test for software.

### BACKGROUND

Conventionally, when the design verification of the hardware or the test of the software is carried out, a method is adopted in which boundary conditions (e.g. conditions of branches and/or loops and the like) are extracted from an internal structure of a verification target (i.e. hardware or software), and input patterns to operate the verification target at values close to the boundary conditions are generated. However, when the conditions are complex, it is difficult to create the input patterns from the boundary conditions automatically or manually. Therefore, there is a problem that a long time is required to generate effective patterns.

In addition, there is a technique that the test is carried out by using patterns created in advance, and for the test, the total number of patterns is reduced by selecting or creating patterns that improves coverage (e.g. line coverage). However, this technique does not consider the boundary conditions of the verification target.

In order to efficiently carry out the design verification of the hardware or the test of the software, it is necessary to operate the verification target at points close to the boundary conditions. However, it is very difficult for the conventional techniques to generate the input patterns to operate the verification target at the points close to the boundary conditions, because the input patterns are generated based on the internal structure of the verification target.

Namely, it is impossible for the conventional technique to automatically extract test patterns to operate the verification target at the points close to the boundary conditions without analyzing the internal structure of the verification target.

### SUMMARY

According to an aspect of this technique, this test pattern extraction method includes obtaining an identifier of a processing executed for a test pattern by a verification target, and storing the identifier of the processing into a test result data storage device in association with the test pattern; calculating a distance between the test patterns whose identifiers of the processing are different each other and which are stored in the test result data storage device, identifying, for each group of the identifiers of the processing, a group of the test patterns whose distance satisfies a predetermined condition, and storing data of the identified group of the test patterns into a pattern data storage device.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram of a test pattern extraction apparatus relating to an embodiment;

FIG. 2 is a diagram depicting an example of a function F(x, y) of a verification target;

FIG. 3 is a diagram depicting correspondence relation between the values of the arguments of the function F and processing types;

FIG. 4 is a schematically diagram depicting correspondence relation test patterns and the processing types in a case where the test patterns are generated randomly;

FIG. 5 is a diagram depicting a main processing flow in the embodiment;

FIG. 6 is a diagram depicting a processing flow of a test processing;

FIG. 7 is a diagram depicting an example of data stored in a test result storage;

FIG. 8 is a schematic diagram to explain a test pattern pair to be selected;

FIG. 9 is a diagram depicting a processing flow of a pattern selection processing;

FIG. 10 is a diagram depicting the processing flow of the pattern selection processing;

FIG. 11 is a diagram depicting an example of data stored in a solution set data storage;

FIG. 12 is a diagram depicting a processing flow of a first pattern generation processing;

FIGS. 13A and 13B are a diagram to explain a second pattern generation processing;

FIG. 14 is a diagram depicting a processing flow of the second pattern generation processing;

FIG. 15 is a diagram to explain contents of the second pattern generation processing;

FIG. 16 is a diagram depicting an example of data stored in a generated pattern data storage;

FIG. 17 is a diagram to explain calculation of weighted distances; and

FIG. 18 is a functional block diagram of a computer.

### DESCRIPTION OF EMBODIMENTS

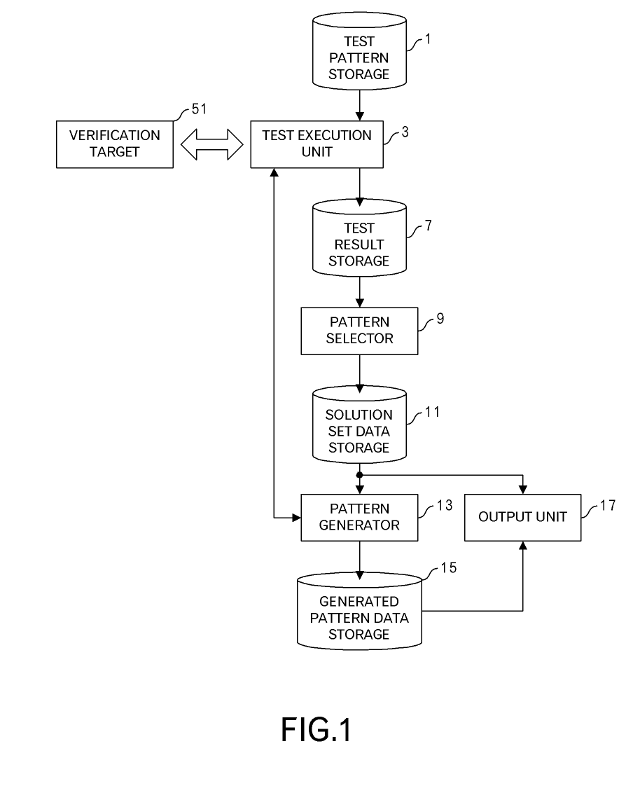

FIG. 1 depicts a functional block diagram of a test pattern extraction apparatus in one embodiment of this technique. The text pattern extraction apparatus has a test pattern storage 1 that stores test patterns (also called “pattern” or “input pattern”) to be executed in the hardware or software of the verification target 51 or information (e.g. data designating a value range of a specific variable or the like) to identify the test patterns; a test execution unit 3 that causes the verification target 51 to execute a processing (i.e. perform a function) according to data stored in the test pattern storage 1, and obtains an identifier of the processing executed (i.e. the function performed), which representing which processing (i.e. function) is carried out; a test result storage 7 that stores the identifier of the processing, which is obtained by the test execution unit 3, in association with the test pattern; a pattern selector 9 that carries out a processing to select test patterns, which are admitted to be close to the boundary condition, among the test patterns stored in the test result storage 7; a solution set data storage 11 that stores data of the test patterns selected by the pattern selector 9; a pattern generator 13 that carries out a processing to generate a test pattern that becomes much closer to the boundary condition for the test patterns stored in the solution set data storage 11; a generated pattern data storage 15 that stores a processing result of the pattern generator 13; and an output unit 17 that outputs data stored in the solution set data storage 11 or generated pattern data storage 15.

The verification target 51 is, for example, software to be verified, hardware described, for example, by Hardware Description Language (HDL) or the like. The test execution unit 3 is, for example, a debugger for the verification target 51, and by a coverage obtaining function that the debugger normally has, an identifier of the processing (i.e. the function), which represents which processing (i.e. function) is carried out, is obtained.

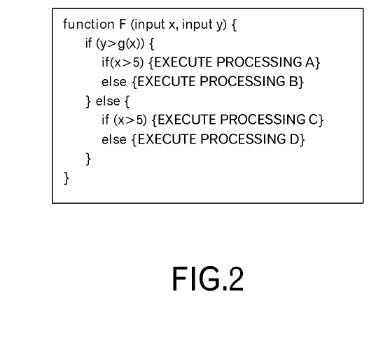

For example, a case is considered where a function F(x, y) having two arguments as depicted in FIG. 2 is tested. As for this function F(x, y), when y is greater than a function g(x) and x is greater than 5, a processing A (i.e. a function A) is carried out, when y is greater than the function g(x) and x is equal to or less than 5, a processing B (i.e. a function B) is carried out, when y is equal to or less than the function g(x) and x is greater than 5, a processing C (i.e. a function C) is carried out and when y is equal to or less than the function g(x) and x is equal to or less the 5, a processing D (i.e. a function D) is carried out. Here, it is assumed that a permissible range of x is 0≦x≦10, and a permissible range of y is 0≦y≦10.

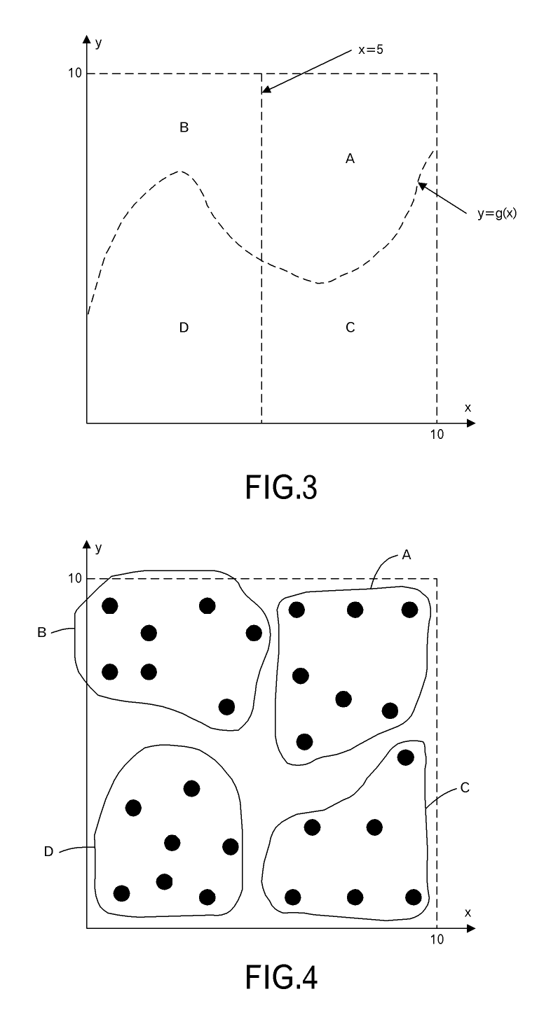

In such a case, a correspondence relation between values of arguments and processing types (i.e. function types) is schematically depicted in FIG. 3. In a graph of FIG. 3, in the aforementioned value ranges of x and y, different processing (i.e. different function) is carried out in respective four regions A to D sectioned by x=5 and y=g(x). Therefore, it is preferable that the test patterns close to the boundaries of each region as much as possible are identified. However, the structure of the verification target as depicted in FIG. 2 cannot be always analyzed from the outside.

In this embodiment, within the aforementioned value ranges of x and y, test patterns (x, y) are generated, for example, randomly, and are inputted to a function F(x, y) to actually operate the function F(x, y), and it is identified by the test execution unit 3 including the coverage obtaining function of the debugger and the like, which processing of the processing A to D (i.e. the functions A to D) was carried out. As depicted in FIG. 4, a black circle represents a test pattern which is a combination of x and y generated randomly, and one of the processing A to D (i.e. the functions A to D) is carried out according to the region, as depicted in FIG. 3, to which the test pattern belongs. The test execution unit 3 identifies an identifier (A to D) of the processing for each of the test patterns (e.g. the black circles).

Incidentally, for example, (x, y) may be prepared and stored in advance in the test pattern storage 1 in the examples of FIGS. 2 to 4. In addition, for example, data of the value ranges of the aforementioned x and y and data designating a generation method such as a randomly generating may be stored, and the test execution unit 3 may generate a specific test pattern as occasion demands.

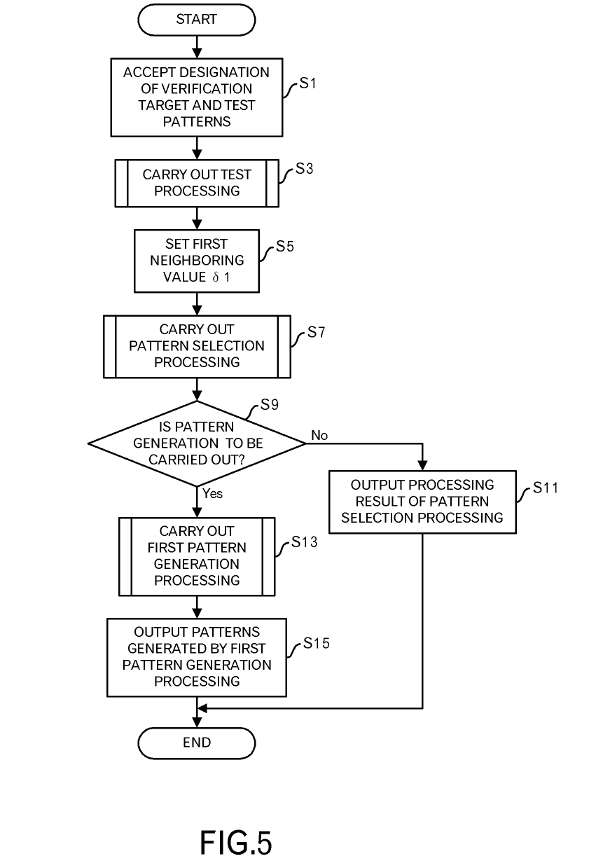

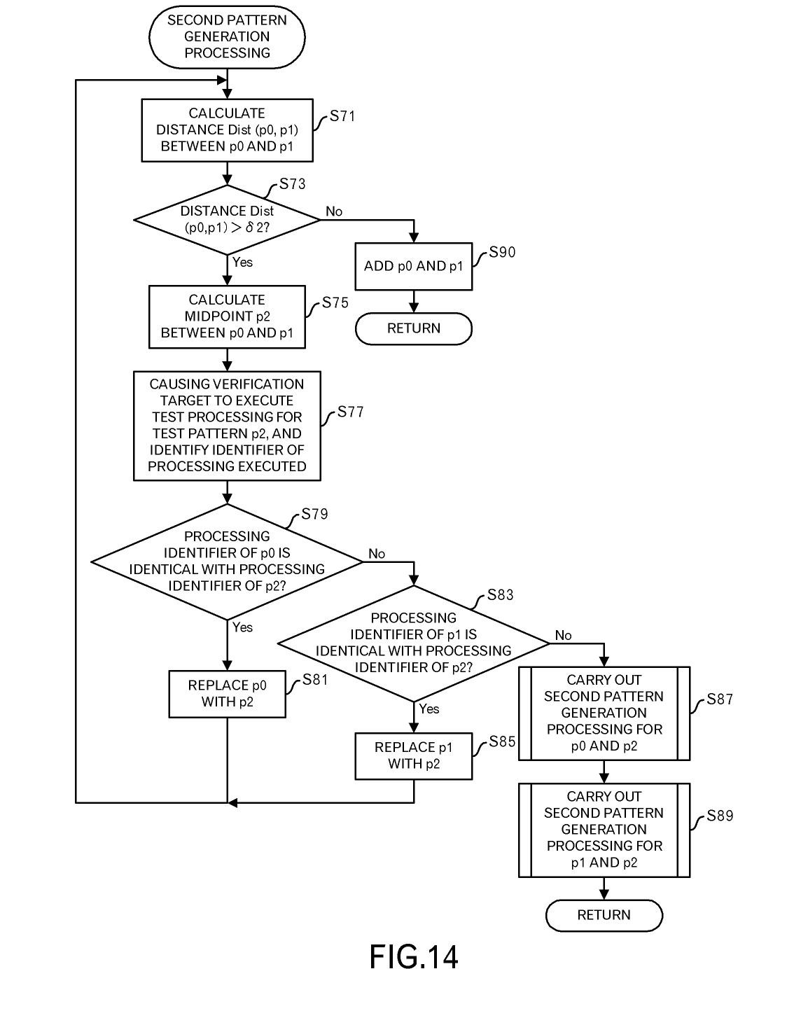

Next, processing contents of the test pattern extraction apparatus depicted in FIG. 1 will be explained by using FIGS. 5 to 17. First, for example, the test execution unit 3 accepts designation of the verification target 51 and test patterns from a user (step S1). The test pattern stored in the test pattern storage 1 may be designated, or a test pattern generation method may be designated to generate the test pattern. In addition, data of the test pattern generation method may be stored in the test pattern storage 1 and the start of the processing using the data of the test pattern generation method may be instructed.

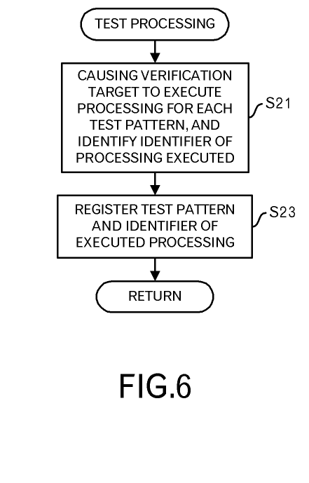

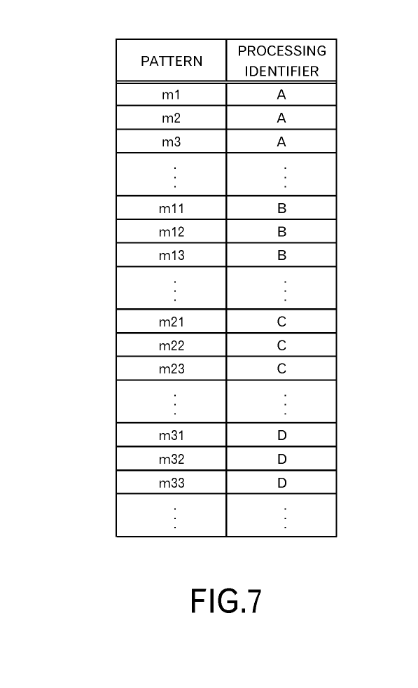

Then, the text execution unit 3 carries out a test processing (step S3). The test processing will be explained by using FIGS. 6 and 7. The test execution unit 3 causes the verification target 51 to execute a processing for the respective designated test patterns stored in the test pattern storage 1, and identifies identifiers of the processing executed by the verification target 51 (step S21). Then, the test execution unit 3 stores pairs of the designated test pattern and identifier of the processing executed by the verification target 51 into the test result storage 7 (step S23). For example, data as depicted in FIG. 7 is stored into the test result storage 7. Namely, the test pattern (e.g. m1=(x1, y1)) is registered in association with the processing identifier (i.e. function identifier) (e.g. A).

Returning to the explanation of the processing of FIG. 5, next, the pattern selector 9 sets a first neighboring value δ1 (step S5). For example, a fixed neighboring value, which was set in advance, may be used, and after prompting the user to input a value, the value inputted by the user may be used.

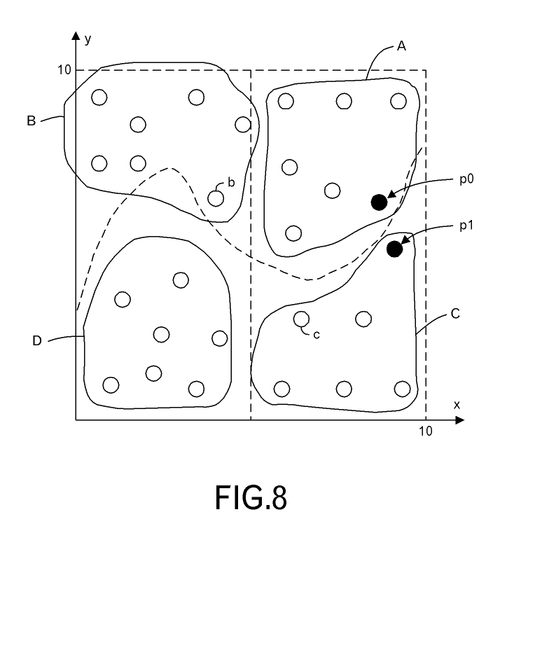

Then, the pattern selector 9 carries out a pattern selection processing (step S7). The pattern selection processing will be explained by using FIGS. 8 to 11.

As schematically depicted in FIG. 8, the pattern selection processing is a processing to extract test patterns p0 and p1, between which the distance is the shortest (i.e. adjacent most), among the test patterns causing the verification target 51 to execute different processing (e.g. processing A and processing C (i.e. functions A and C)). Incidentally, in this embodiment, the test pattern extraction condition also includes a condition that the distance between the test patterns p0 and p1 is less than the first neighboring value δ1.

Then, the pattern selector 9 identifies one unprocessed processing identifier s0 (i.e. function identifier s0) among the processing identifiers (i.e. the function identifiers) stored in the test result storage 7 (step S31). In addition, the pattern selector 9 identifies one unprocessed processing identifier s1 (i.e. function identifier s1) different from s0 among the processing identifiers (i.e. the function identifiers) stored in the test result storage 7 (step S33). Then, the pattern selector 9 initially set the infinite to a variable mid_dist storing the distance (step S35). Furthermore, the pattern selector 9 identifies an unprocessed test pattern p0 relating to the processing identifier s0, among the test patterns stored in the test result storage 7 (step S37). In addition, the pattern selector 9 identifies an unprocessed test pattern p0 relating to the processing identifier s1, among the test patterns stored in the test result storage 7 (step S39).

Then, the pattern selector 9 calculates the distance Dist (p0, p1) between the test patterns p0 and p1 (step S41). The distance between X and Y is calculated according to the following equation, for example.

$$Dist ( X , Y ) = \sqrt{{\sum }_{i = 1}^{n} {( Xi - Yi )}^{2}} \qquad ( 1 )$$

Incidentally, it is assumed that X and Y respectively include n elements.

Then, the pattern selector 9 judges whether or not Dist (p0, p1) is less than min dist (step S43). In the first processing, because min dist is infinite, Dist (p0, p1)<min_dist is always satisfied. After the first processing, the judgment result varies in every cases.

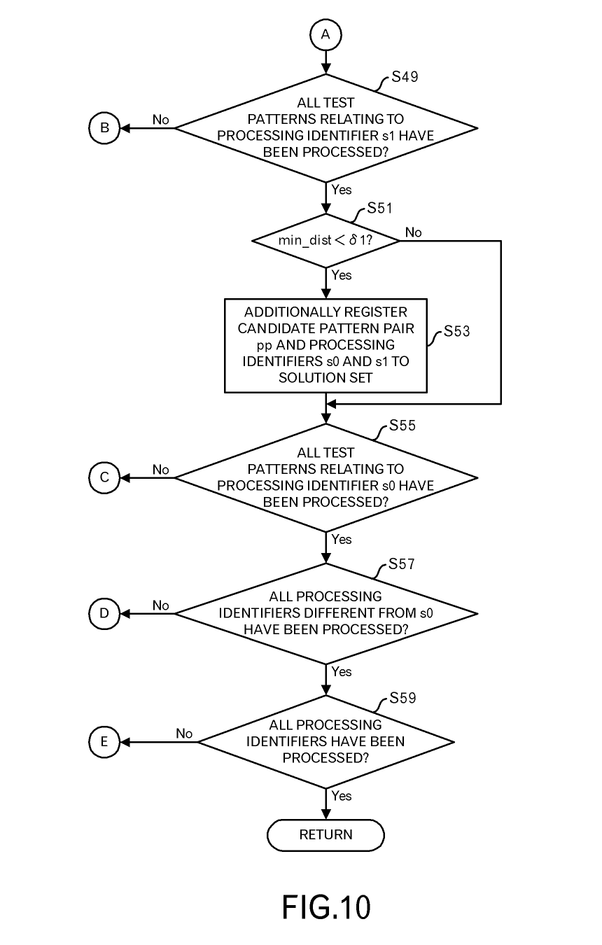

When Dist (p0, p1) is equal to or greater than min_dist, the process shifts to the process of FIG. 10 through a terminal A. On the other hand, when Dist (p0, p1) is less than min_dist, the pattern selector 9 substitutes Dist (p0, p1) into min_dist (step S45). Then, the pattern selector 9 sets the test patterns p0 and p1 to a candidate pattern pair pp (step S47). Then, the process shifts to the process of FIG. 10 through the terminal A.

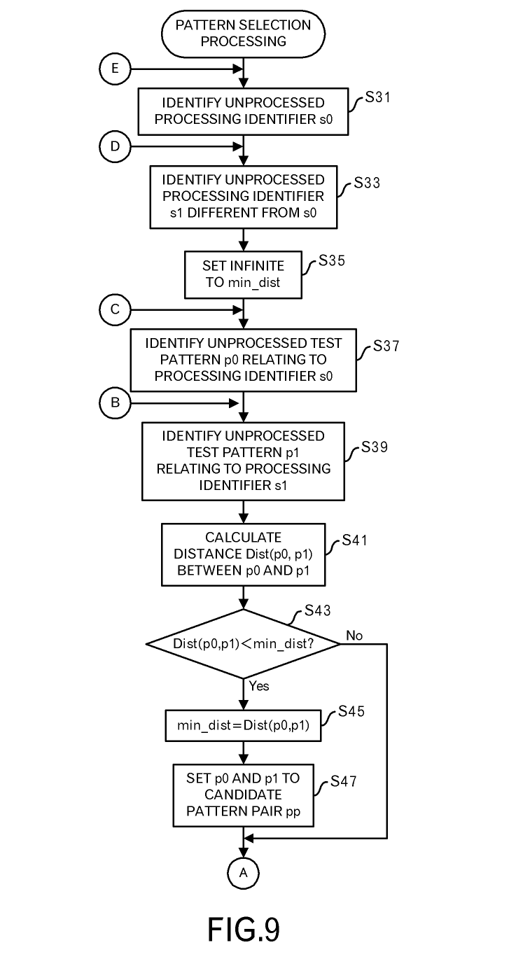

Shifting to the explanation of the process in FIG. 10, the pattern selector 9 judges whether or not all test patterns relating to the processing identifier s1 have been processed (step S49). When an unprocessed test pattern relating to the processing identifier s1 exists, the process returns to the step S39 of FIG. 9 through a terminal B.

When all test patterns relating to the processing identifier s1 have been processed, the pattern selector 9 judges whether or not min_dist is shorter than the first neighboring value δ1 (step S51). When min_dist is equal to or longer than the first neighboring value δ1, the process shifts to step S55. Namely, the candidate test pattern pair pp including the test patterns p0 and p1, whose distance is min_dist, is not adopted. In the example of FIG. 8, for example, the test patterns c and b are surely test patterns for which different processing (i.e. different function) is carried out. However, it is judges that their adoption has no meaning, because they are too far away.

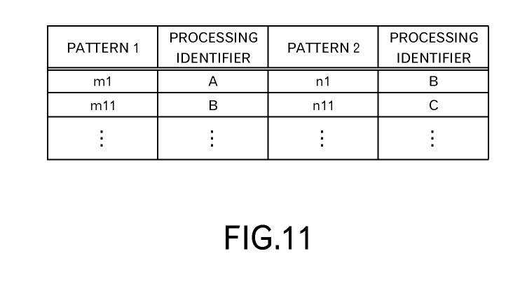

On the other hand, when min dist is less than the first neighboring value δ1, the pattern selector 9 additionally registers the candidate test pattern pair pp (i.e. pertinent test patterns p0 and p1) whose distance is min_dist, and the processing identifiers s0 and s1 for the candidate test pattern pair pp to a solution set (step S53). Namely, data as depicted in FIG. 11 is stored into the solution set data storage 11.

In the example of FIG. 11, two test patterns included in the candidate test pattern pair pp, which finally remained, and two corresponding processing identifiers are registered as one record.

After that, the pattern selector 9 judges whether or not all test patterns relating to the processing identifier s0 have been processed (step S55). When an unprocessed test pattern exists among the test patterns relating to the processing identifier s0, the process returns to the step S37 of FIG. 9 through a terminal C.

On the other hand, when all test patterns relating to the processing identifier s0 have been processed, the pattern selector 9 judges whether or not all processing identifiers different from the processing identifier s0 have been processed (step S57). When an unprocessed processing identifier different from the processing identifier s0 exists, the process returns to the step S33 of FIG. 9 through a terminal D.

In addition, when all processing identifiers different from the processing identifier s0 have been processed, the pattern selector 9 judges whether or not all of the processing identifiers to be set to the processing identifier s0 have been processed (step S59). When an unprocessed processing identifier to be set to the processing identifier s0 exists, the process returns to the step S31 of FIG. 9 through a terminal E.

On the other hand, when all of the processing identifiers to be set to the processing identifier s0 have been processed, the process returns to the original process.

By carrying out such a processing, the test patterns relating to the different processing (i.e. the different functions) and whose distance is the shortest and shorter than the first neighboring value δ1 can be identified.

Incidentally, in the aforementioned processing flow, the test patterns identified for a pair of the processing A and B (i.e. the functions A and B) are identical with the test patterns identified for a pair of the processing B and A (i.e. the functions B and A), and the combination of the processing A and B and the combination of the processing B and A are separately processed. However, only the combination of the processing A and B may be processed.

Returning to the explanation of the process in FIG. 5, for example, the output unit 17 judges whether or not the pattern generation is carried out (step S9). For example, it is judged whether or not the performance of the pattern generation processing is set in advance or instructed by the user.

When the pattern generation is not carried out, the output unit 17 outputs data of the processing result (e.g. FIG. 11) of the pattern selection processing, which is stored in the solution set data storage 11 (step S11). For example, the processing result is displayed on a display device or printed by a printer. Furthermore, the processing result may be stored into another file or data storage device.

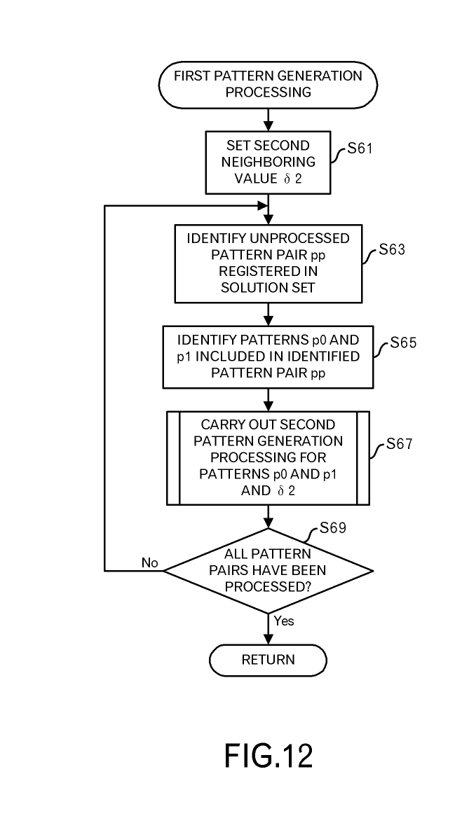

On the other hand, the pattern generator 13 carries out a first pattern generation processing (step S13). The first pattern generation processing will be explained by using FIG. 12.

First, the pattern generator 13 sets a second neighboring value δ2 (step S61). For example, a fixed value, which was set in advance, may be used, and after prompting the user to input a value, the value inputted by the user may be used.

Next, the pattern generator 13 identifies one unprocessed test pattern pair pp stored in the solution set data storage 11 (step S63). In addition, the pattern generator 13 identifies the test patterns p0 and p1 included in the identified test pattern pair pp (step S65).

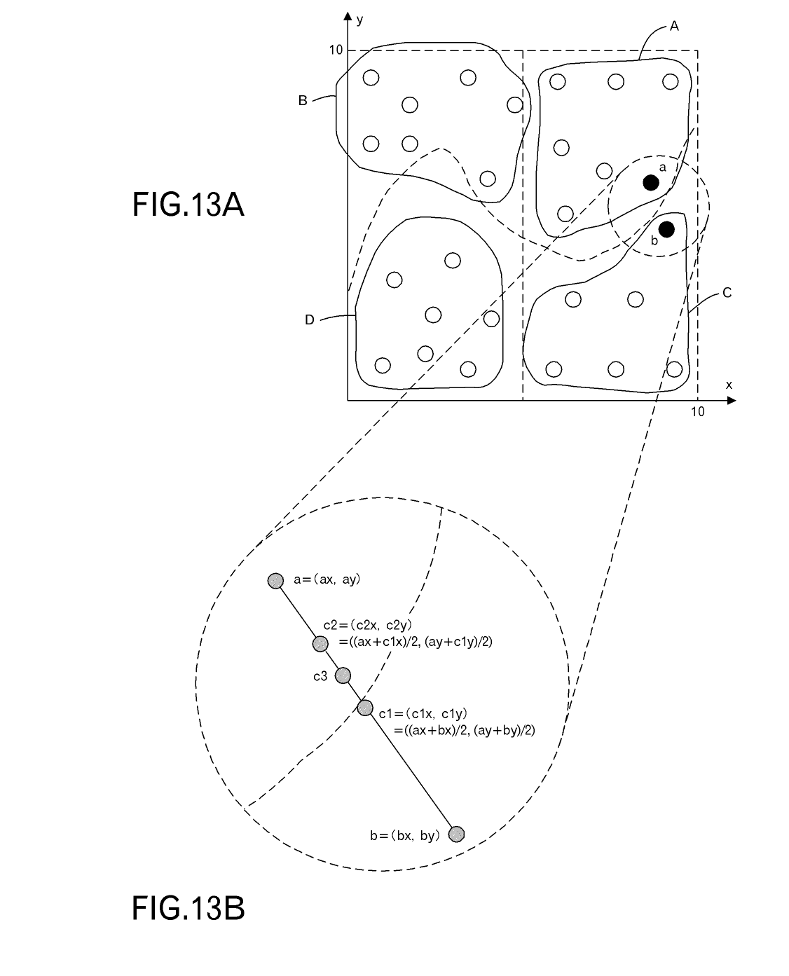

Then, the pattern generator 13 carries out a second pattern generation processing for the test patterns p0 and p1 and the second neighboring value δ2 (step S67). This second pattern generation processing will be explained by using FIGS. 13A to 16.

First, an outline of the second pattern generation processing will be explained by using FIGS. 13A and 13B. Here, it is assumed that the test patterns a (=(ax, ay)) and b (=(bx, by)) depicted in FIG. 13A are stored in the solution set data storage 11. Here, in this embodiment, as depicted in FIG. 13B, a midpoint c1 (=(c1x, c1y)=((ax+bx)/2, (ay+by)/2) of the test patterns a and b is calculated. It is identified which processing (i.e. which function) the verification target 51 carries out for this midpoint c1. It is assumed that the processing C (i.e. the function C) is carried out for the midpoint c1. Then, the test pattern b is replaced with the midpoint c1. Here, the distance between the test pattern a and the midpoint c1 is calculated, and it is judged whether or not the distance is less than the second neighboring point δ2.

When the distance between the test pattern a and the midpoint c1 is longer than the second neighboring value δ2, a mid point c2 (=(c2x, c2y)=((ax+c1x)/2, (ay+c1y)/2)) is calculated. Then, it is identified which processing (i.e. which function) the verification target 51 carries out for this midpoint c2. Here, it is assumed that the processing A (i.e. the function A) is carried out for the midpoint c2. Then, the test pattern a is replaced with the midpoint c2. Here, the distance between the midpoints c2 and c1 is calculated and it is judged whether or not the distance is equal to or shorter than the second neighboring value δ2.

When the distance between the midpoints c2 and c1 is longer than the second neighboring value δ2, a midpoint c3 (=(c3x, c3y)=((c2x+c1x)/2, (c2y+c1y)/2)) is calculated. Then, it is identified which processing (i.e. which function) the verification target 51 carries out for this midpoint c3. Here, it is assumed that the processing A (i.e. the function A) is carried out for the midpoint c3. Then, the midpoint c2 is replaced with the midpoint c3. Here, the distance between the midpoints c3 and c1 is calculated, and it is judged whether or not the distance is equal to or shorter than the second neighboring value δ2. In this example, it is judged here that the distance between the midpoints c3 and c1 is equal to or shorter than the second neighboring value δ2, and the second pattern generation processing is completed.

According to the aforementioned outline, the pattern generator 13 calculates the distance Dist (p0, p1) between the test patterns p0 and p1 (step S71). For example, the distance is calculated according to the equation (1). Then, the pattern generator 13 judges whether or not the distance Dist (p0, p1) exceeds the second neighboring value δ2 (step S73). When the distance Dist (p0, p1) exceeds the second neighboring value δ2, it is determined that a test pattern that is much closer to the boundary can be generated, and when the distance Dist (p0, p1) is equal to or shorter than the second neighboring value δ2, it is determined that it is not necessary to generate a test pattern much closer to the boundary.

When the distance Dist (p0, p1) exceeds the second neighboring value δ2, the pattern generator 13 calculates a midpoint p2 between the test patterns p0 and p1 (step S75) The midpoint between X and Y is calculated as follows:

$$Mid ( X , Y ) = ( {m}_{1} , {m}_{2} , … , {m}_{n} )$$

$${m}_{i} = \frac{( {X}_{i} + {Y}_{i} )}{2}$$

As described above, X and Y respectively include n elements, and an average is calculated for each element.

Then, the pattern generator 13 causes the test execution unit 3 to execute a processing (i.e. a function) for the test pattern p2 and causes the test execution unit 3 to identify an identifier of the executed processing (i.e. the executed function) (step S77). The identifier of the processing (i.e. the function) is obtained from the test execution unit 3. Then, the pattern generator 13 judges whether or not the processing identifier (i.e. the function identifier) of the test pattern p0 is identical with the processing identifier of the test pattern p2 (step S79).

When the processing identifier of the test pattern p0 is identical with the processing identifier of the test pattern p2, the pattern generator 13 replaces the test pattern p0 with the test pattern p2 (step S81). Then, the processing returns to the step S71.

On the other hand, when the processing identifier of the test pattern p0 is different from the processing identifier of the test pattern p2, the pattern generator 13 judges whether or not the processing identifier of the test pattern p1 is identical with the processing identifier of the test pattern p2 (step S83). When the processing identifier of the test pattern p1 is identical with the processing identifier of the test pattern p2, the pattern generator 13 replaces the test pattern p1 with the test pattern p2 (step S85). Then, the processing returns to the step S71.

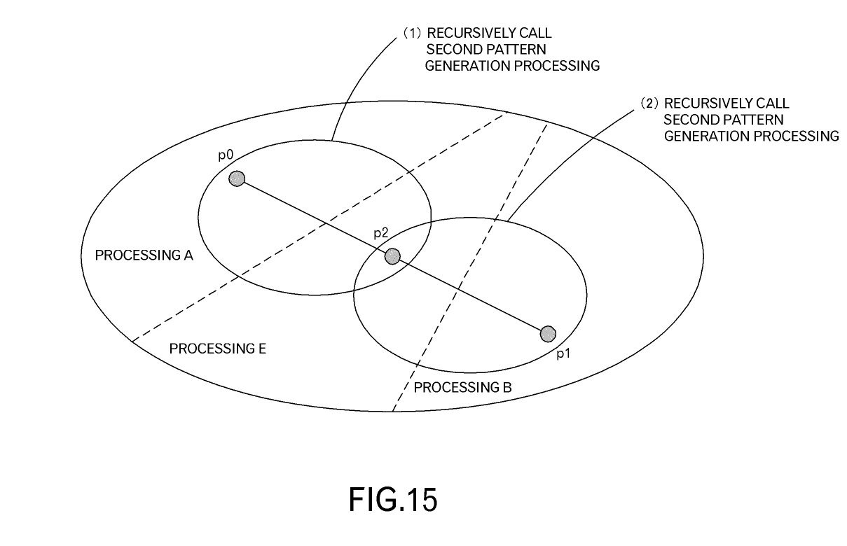

On the other hand, when the processing identifier of the test pattern p1 is different from the processing identifier of the test pattern p2, it is determined that a state as depicted in FIG. 15 occurs. Namely, a region in which the processing A (i.e. the function A) is executed does not directly face a region in which the processing B (i.e. the function B) is executed, a region in which the processing E (i.e. the function E) is executed exists between the aforementioned regions, and the test pattern p2 of the midpoint belongs to the region in which the processing E is executed.

In such a case, the pattern generator 13 carries out the second pattern generation processing for the test patterns p0 and p1 as depicted in (1) of FIG. 15 (step S87). Furthermore, as depicted in (2) of FIG. 15, the pattern generator 13 carries out the second pattern generation processing for the test patterns p1 and p2 (step S89). Then, the process returns to the original process.

Thus, test patterns close to the boundaries of the region in which the processing A (i.e. the function A) is carried out and the region in which the processing E (i.e. the function E) is carried out are generated, and test patterns close to the boundaries of the region in which the processing E (i.e. the function E) is carried out and the region in which the processing B (i.e. the function B) is carried out are generated.

When it is judged at the step S73 that the distance Dist (p0, p1) is shorter than the second neighboring value δ2, the pattern generator 13 stores the test patterns p0 and p1 at that time into the generated pattern data storage 15 (step S90). Then, the process returns to the original process.

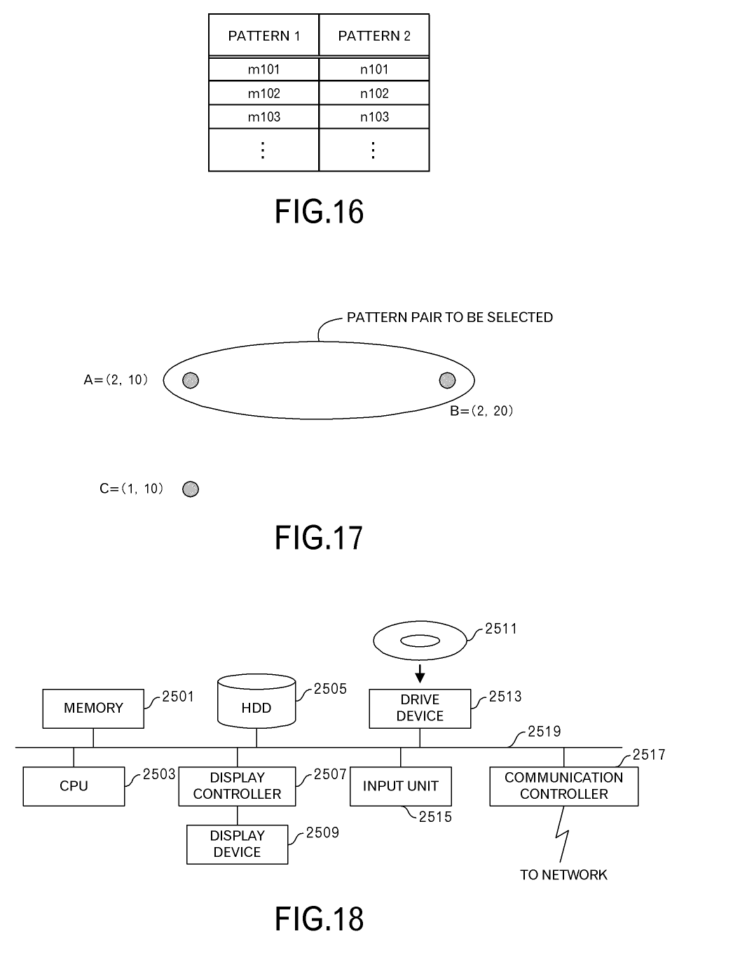

The generated pattern data storage 15 stores data as depicted in FIG. 16, for example. Namely, two test patterns, which are newly generated, are registered. Incidentally, there is a case where records whose number is greater than the records stored in the solution set data storage 11 may be registered into the generated pattern data storage 15.

By carrying out the aforementioned process, the test pattern which is much closer to the boundary can be generated.

Returning to the explanation of the process in FIG. 12, the pattern generator 13 judges whether or not all of the test patterns stored in the solution set data storage 11 have been processed (step S69). When an unprocessed test pattern pair is stored in the solution set data storage 11, the process returns to the step S63. On the other hand, when all of the test pattern pairs have been processed, the process returns to the original process.

Returning to the explanation of the process of FIG. 5, the output unit 17 outputs sets of test patterns, which were generated in the first pattern generation processing and stored in the generated pattern data storage 15 (step S15). For example, the set of test patterns may be displayed and may be printed by the printer. Furthermore, data may be stored into another file or data storage device.

By carrying out such a processing, it becomes possible to automatically extract the test patterns for operating the verification target 51 at points close to the boundary conditions without analyzing the internal structure of the verification target 51.

Incidentally, in the aforementioned embodiment, an example is indicated that elements (i.e. variables) included in the test pattern is equally handled. However, because the value range of the control variable is narrower than that of the data variable, there is a tendency that a large number of value combinations of the control variable are tested. On the other hand, as for the data variable, only typical value combinations are often tested. In addition, when there is a processing branch by the data variable in the verification target 51, there are a lot of cases where the workload to generate the pattern for the boundary conditions of the data variable is larger than the work load to generate the patterns for the boundary conditions by the control variable, and there is high possibility that the boundary conditions depending on the data variable are missed.

In addition, compared with the control variable, there is a tendency that the value range of the data variable is wide, and the difference between the variable values of test patterns is large, and it becomes easy to select the boundary values depending on the data variable in the equation for calculating the distance. Then, by reducing the weight of the difference of the values of the control variable rather than that of the difference of the values of the data variable, it is made easy to select the test pattern pair according to the difference of the values of the data variable.

For example, in the example as depicted in FIG. 17, when two variables x and y are equal, the test patterns A and C are selected, because Dist (A, B)=10>Dist (A, C)=1.

On the other hand, a weight coefficient wx=10000 is set for the control variable x whose value range is 0≦x≦5, and a weight coefficient wy=5 is set for the data variable y whose value range is 0≦y≦10000. Then, the distance WeightedDist (W, X, Y) is defined as follows:

$$WeightedDist ( W , X , Y ) = \sqrt{{\sum }_{i = 1}^{n} {{w}_{i} ( {X}_{i} - {Y}_{i} )}^{2}} \qquad ( 2 )$$

Incidentally, the greater value the weight coefficient is, the longer the distance is. Therefore, the smaller weight is assigned to the variable relating to such weight coefficient.

In the example, WeightedDist(W, A, B)=22<WeightedDist (W, A, C)=100 is satisfied. Therefore, test patters A and B are selected.

Therefore, when the data variable or control variable and its weight coefficient are designated, for example, from the user, the pattern selector 9 and pattern generator 13 calculates the distance according to the aforementioned equation (2). In addition, the variable whose value range is narrow may be identified as the control variable, and the value range of the data variable may be designated for the weight coefficient of the control variable. Similarly, the variable whose value range is wide may be identified as the data variable, and the value range of the control variable may be designated for the weight coefficient of the data variable.

Although this embodiment is explained above, the embodiment is not limited to this embodiment. For example, the functional block diagram of FIG. 1 is a mere example, and it does not always correspond to the actual program module configuration.

Furthermore, when the processing result is not changed, the processing order may be replaced or may be executed in parallel.

This embodiment described above can be summarized as follows:

This test pattern extraction method includes obtaining an identifier of a processing executed for a test pattern by a verification target, and storing the identifier of the processing into a test result data storage device in association with the test pattern; calculating a distance between the test patterns whose identifiers of the processing are different each other and which are stored in the test result data storage device, identifying, for each pair of the identifiers of the processing, a pair of the test patterns whose distance satisfies a predetermined condition, and storing data of the identified pair of the test patterns into a pattern data storage device.

Thus, it becomes possible to automatically extract the pair of the test patterns close to the boundary conditions without analyzing the internal structure of the verification target.

In addition, the test pattern extraction method may further include generating a pair of test patterns whose distance is much shorter from the pairs of the test patterns, which are stored in the pattern data storage device, and storing the generated pair of test patterns into the generated pattern data storage device. Thus, it becomes possible to generate the pair of test patterns which are much closer to the boundary. For example, the test patterns may be brought to the boundary until a pair of test patterns whose distance is less than a second threshold can be obtained.

Incidentally, the aforementioned predetermined condition may be a condition that the distance between the test patterns is minimum for the pair of identifiers of the processing and is shorter than a predetermined threshold. The predetermined condition may be only a condition that the distance is minimum.

Furthermore, the identifier of the processing is registered in the aforementioned pattern data storage in association with the test pattern. Then, the aforementioned generating may include: calculating a candidate test pattern that is a midpoint between the first and second test patterns, and obtaining the identifier of the processing executed by the verification target for the candidate test pattern; judging whether or not the identifier of the processing executed for the candidate test pattern is identical to the identifier of the processing executed for the first or second test pattern; when the identifier of the processing executed for the candidate test pattern is identical with the identifier of the processing executed for the first test pattern, replacing the first test pattern with the candidate test pattern, and calculating a second distance between the first and second test patterns; when the identifier of the processing executed for the candidate test pattern is identical with the identifier of the processing executed for the second test pattern, replacing the second test pattern with the candidate test pattern, and calculating the second distance between the first and second test patterns; when the second distance is shorter than a second predetermined threshold, storing the first and second test patterns into the generated pattern data storage.

This enables the test pattern much closer to the boundary to be automatically generated.

In addition, the aforementioned generating may further include, when the identifier of the processing executed for the candidate test pattern is different from the identifiers of the processing executed for the first and second test patterns, carrying out the generating for the first test pattern and the candidate test pattern, and carrying out the generating for the second test pattern and the candidate test pattern.

Incidentally, the aforementioned distance may be a distance weighted according to the variable included in the test pattern. By calculating the distance weighted, for example, on the data variable, not simple Euclid distance, it becomes possible to select or generate appropriate test patterns.

Incidentally, it is possible to create a program causing a computer to execute the aforementioned method, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

In addition, the aforementioned test pattern extraction apparatus is a computer device as shown in FIG. 18. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 18. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the computer-readable removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in detail are realized.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer readable storage medium storing a test pattern extraction program for causing a computer to a process, comprising:
obtaining an identifier of a processing executed for a test pattern by a verification target, and storing said identifier of said processing into a test result data storage device in association with said test pattern; and
calculating a distance between said test patterns whose identifiers of said processing are different each other and which are stored in said test result data storage device, identifying, for each pair of said identifiers of said processing, a pair of said test patterns whose distance satisfies a predetermined condition, and storing data of the identified pair of said test patterns into a pattern data storage device.

2. The computer readable storage medium as set forth in claim 1, wherein said process further comprises:
generating a pair of test patterns whose distance is much shorter, from said pairs of said test patterns, which are stored in said pattern data storage device, and storing the generated pair of test patterns into a generated pattern data storage device.

3. The computer readable storage medium as set forth in claim 1, wherein said predetermined condition is a condition that said distance between said test patterns is minimum for said pair of said identifiers of said processing and is shorter than a predetermined threshold.

4. The computer readable storage medium as set forth in claim 2, wherein said identifier of said processing is registered in said pattern data storage in association with said test pattern, and said generating comprises:
calculating a candidate test pattern that is a midpoint between first and second test patterns, and obtaining an identifier of a processing executed by said verification target for said candidate test pattern;
judging whether or not said identifier of said processing executed for said candidate test pattern is identical to said identifier of said processing executed for said first or second test pattern;
upon being judged that said identifier of said processing executed for said candidate test pattern is identical with said identifier of said processing executed for said first test pattern, replacing said first test pattern with said candidate test pattern, and calculating a second distance between said first and second test patterns;
upon being judged that said identifier of said processing executed for said candidate test pattern is identical with said identifier of said processing executed for said second test pattern, replacing said second test pattern with said candidate test pattern, and calculating a second distance between said first and second test patterns; and
upon being determined that said second distance is shorter than a second predetermined threshold, storing said first and second test patterns into said generated pattern data storage device.

5. The computer readable storage medium as set forth in claim 4, wherein said generating further comprises: upon being determined that said identifier of said processing executed for said candidate test pattern is different from said identifiers of said processing executed for said first and second test patterns, carrying out said generating for a pair of said first test pattern and said candidate test pattern, and carrying out said generating for a pair of said second test pattern and said candidate test pattern.

6. The computer readable storage medium as set forth in claim 1, wherein said distance is a distance weighted according to a variable included in said test pattern.

7. A test pattern extraction method, wherein said test pattern extraction method is executed by a computer including a test result data storage and a pattern data storage device, and said test pattern extraction method comprises:
obtaining an identifier of a processing executed for a test pattern by a verification target, and storing said identifier of said processing into said test result data storage device in association with said test pattern; and
calculating a distance between said test patterns whose identifiers of said processing are different each other and which are stored in said test result data storage device, identifying, for each pair of said identifiers of said processing, a pair of said test patterns whose distance satisfies a predetermined condition, and storing data of the identified pair of said test patterns into said pattern data storage device.

8. The test pattern extraction method as set forth in claim 7, further comprises:
generating a pair of test patterns whose distance is much shorter, from said pairs of said test patterns, which are stored in said pattern data storage device, and storing the generated pair of test patterns into a generated pattern data storage device.

9. The test pattern extraction method as set forth in claim 7, wherein said predetermined condition is a condition that said distance between said test patterns is minimum for said pair of said identifiers of said processing and is shorter than a predetermined threshold.

10. The test pattern extraction method as set forth in claim 8, wherein said identifier of said processing is registered in said pattern data storage in association with said test pattern, and said generating comprises:
calculating a candidate test pattern that is a midpoint between first and second test patterns, and obtaining an identifier of a processing executed by said verification target for said candidate test pattern;
judging whether or not said identifier of said processing executed for said candidate test pattern is identical to said identifier of said processing executed for said first or second test pattern;
upon being judged that said identifier of said processing executed for said candidate test pattern is identical with said identifier of said processing executed for said first test pattern, replacing said first test pattern with said candidate test pattern, and calculating a second distance between said first and second test patterns;
upon being judged that said identifier of said processing executed for said candidate test pattern is identical with said identifier of said processing executed for said second test pattern, replacing said second test pattern with said candidate test pattern, and calculating a second distance between said first and second test patterns; and
upon being determined that said second distance is shorter than a second predetermined threshold, storing said first and second test patterns into said generated pattern data storage device.

11. The test pattern extraction method as set forth in claim 10, wherein said generating further comprises: upon being determined that said identifier of said processing executed for said candidate test pattern is different from said identifiers of said processing executed for said first and second test patterns, carrying out said generating for a pair of said first test pattern and said candidate test pattern, and carrying out said generating for a pair of said second test pattern and said candidate test pattern.

12. The test pattern extraction method as set forth in claim 7, wherein said distance is a distance weighted according to a variable included in said test pattern.

13. A test pattern extraction apparatus, comprising:
a test result data storage device;
a pattern data storage device:
a unit that obtains an identifier of a processing executed out for a test pattern by a verification target, and stores said identifier of said processing into said test result data storage device in association with said test pattern; and
a unit that calculates a distance between said test patterns whose identifiers of said processing are different each other and which are stored in said test result data storage device, identifying, for each pair of said identifiers of said processing, a pair of said test patterns whose distance satisfies a predetermined condition, and stores data of the identified pair of said test patterns into said pattern data storage device.

14. The test pattern extraction apparatus as set forth in claim 13, further comprising:
a generated pattern data storage device; and
a generator that generates a pair of test patterns whose distance is much shorter, from said pairs of said test patterns, which are stored in said pattern data storage device, and stores the generated pair of test patterns into said generated pattern data storage device.

15. The test pattern extraction apparatus as set forth in claim 13, wherein said predetermined condition is a condition that said distance between said test patterns is minimum for said pair of said identifiers of said processing and is shorter than a predetermined threshold.

16. The test pattern extraction apparatus as set forth in claim 14, wherein said identifier of said processing is registered in said pattern data storage in association with said test pattern, and said generator comprises:
a unit that calculates a candidate test pattern that is a midpoint between first and second test patterns, and obtains an identifier of a processing executed by said verification target for said candidate test pattern;
a unit that judges whether or not said identifier of said processing executed for said candidate test pattern is identical to said identifier of said processing executed for said first or second test pattern;
a unit that replaces, upon judged that said identifier of said processing executed for said candidate test pattern is identical with said identifier of said processing executed for said first test pattern, said first test pattern with said candidate test pattern, and calculates a second distance between said first and second test patterns;
a unit that replaces, upon being judged that said identifier of said processing executed for said candidate test pattern is identical with said identifier of said processing executed for said second test pattern, said second test pattern with said candidate test pattern, and calculates a second distance between said first and second test patterns; and
a unit that stores, upon being determined that said second distance is shorter than a second predetermined threshold, said first and second test patterns into said generated pattern data storage device.

17. The test pattern extraction method as set forth in claim 16, wherein, upon being determined that said identifier of said processing for said candidate test pattern is different from said identifiers of said processing for said first and second test patterns, said generator operates for a pair of said first test pattern and said candidate test pattern, and operates for a pair of said second test pattern and said candidate test pattern.

18. The test pattern extraction method as set forth in claim 13, wherein said distance is a distance weighted according to a variable included in said test pattern.
